(19) United States
(12) Patent Application Publication
(10) Pub. No.: US 2009/0111713 A1
(43) Pub. Date: Apr. 30, 2009

(54) Method for biomolecule immobilization

(75) Inventors: Yu-Chia Tsao, Taipei City (TW); Yi-Wen Yang, Taipei City (TW); Ko-Shao Chen, Taipei City (TW); Tsui-Shan Hung, Taipei City (TW); Shu-Juan Liao, Gueishan Township (TW)

Correspondence Address: BACON & THOMAS, PLLC, 625 SLATERS LANE, FOURTH FLOOR, ALEXANDRIA, VA, 22314-1176, US

(73) Assignee: Forward Electronics Co., Ltd., Taipei City (TW)

(21) Appl. No.: 12/153,911

(22) Filed: May 28, 2008

(30) Foreign Application Priority Data
Oct. 31, 2007 (TW) 096140930

(51) Int. Cl. C40B 50/18

(52) U.S. Cl. 506/32

(57) ABSTRACT

The present invention relates to a method for biomolecule immobilization, comprising: providing a substrate; forming a surface modification layer of carboxy groups on one surface of the substrate, wherein the process for forming the surface modification layer comprises plasma surface modification; and providing pluralities of biomolecules and bonding the biomolecules with the surface modification layer. Accordingly, the method for biomolecule immobilization of the present invention can reduce manufacturing time and enhance the stability of manufacture. In addition, the method can be employed in a biosensor to efficiently enhance sensitivity of the biosensor.

### BACKGROUND OF THE INVENTION

1. Field of the Invention

The present invention relates to a method for biomolecule immobilization and, more particularly, to method for biomolecule immobilization that can reduce manufacturing time and enhance the stability of manufacture.

2. Description of Related Art

Currently, many researchers are devoted to the development of biosensors used for medical diagnosis. A biosensor is constructed of immobilized biomolecules and a signal transducer for measuring the signal variation after the interaction between immobilized biomolecules and bio-samples.

In general, immobilized biomolecules used for sensing bio-samples have to exhibit binding specificity and strong affinity. The commonly used immobilized biomolecules are antibodies, antigens, enzymes, nucleic acids, tissues or cells. In addition, the design trend of the signal transducers is towards diversification, such as field effect transistors, fiber-optic sensors, piezoelectric crystal detectors, surface acoustic wave sensors and so on. Since immobilized biomolecules are required for biosensors, the method for biomolecule immobilization is one of the important techniques in the field of biosensors.

With reference to FIGS. 1A to 1B, there is shown a conventional method for biomolecule immobilization. As shown in FIG. 1A, the surface modification is first performed on the surface of a substrate 11 having a metal film 111 to form a surface modification layer 12. Herein, the conventional surface modification technique is employed in the metal film 111 with surface plasmon resonance spectroscopy. The metal film 111 is a gold film. In order to bond an organic film with the inorganic metal film, the conventional soaking is performed to form a stable coordination bond between an electron pair of a sulfur in an 11-mercaptoundecanoic acid (11-MUA) and an outer vacant orbital of a metal atom so as to form the surface modification layer 12 of COOH groups, as shown in FIG. 1A. Finally, as shown in FIG. 1B, the COOH groups of the surface modification layer 12 are bonded with biomolecules 13 in the presence of a coupling activator, N-(3-dimethylaminopropyl)-N′-ethylcarbodiimide (EDC)/N-hydroxysuccinimide (NHS), to realize biomolecule immobilization.

However, 11-MUA is soluble only in alcohol liquid. Thereby, it is required to mix 11-MUA with alcohol liquid and then perform long-term soaking. Accordingly, the soaking method has the disadvantages of being a time consuming process, and having increased experimental instability and reduced uniformity. In addition, the surface graft density is not easily be controlled.

### SUMMARY OF THE INVENTION

The object of the present invention is to provide a method for biomolecule immobilization so as to reduce manufacturing time, enhance the stability of manufacture and control efficiently the density of bonded molecules. In addition, the method can be employed in a biosensor to efficiently enhance sensitivity of the biosensor.

To achieve the object, the present invention provides a method for biomolecule immobilization, comprising: providing a substrate; forming a surface modification layer of carboxy groups on one surface of the substrate, wherein the process for forming the surface modification layer comprises plasma surface modification; and providing pluralities of biomolecules and bonding the biomolecules with the surface modification layer.

In the method for biomolecule immobilization according to the present invention, the substrate is not limited and can be a silicon substrate. In addition, the substrate can have a metal film on one surface thereof, and the surface modification layer is formed on the surface of the metal film. Accordingly, the biomolecule immobilization can be applied in a sensing area of a fiber biosensor to perform sensing by surface plasmon resonance spectroscopy of the metal film. Herein, the metal film can be a gold film or a silver film.

In the method for biomolecule immobilization according to the present invention, the plasma surface modification is performed by low temperature plasma. Since the plasma surface modification only acts on the surface of the substrate, the nature of the substrate can be maintained. In addition, the plasma surface modification is a dry treatment and thereby has the advantages of rapid and simple process and slight environmental pollution in comparison to the conventional soaking method. Furthermore, the reaction temperature of t he plasma is usually lower than 200° C. and thereby it can be inhibited that high temperature causes the variation in the nature of the substrate. Besides, the plasma surface modification can freely design the chemical composition, control the quality of crosslinking, enhance the stability of manufacture and control efficiently the density of bonded molecules.

In the method for biomolecule immobilization according to the present invention, the plasma surface modification can be performed by plasma polymerization. In plasma polymerization, monomers for plasma polymerization are mixed in low temperature plasma to allow electrons with high energy in the plasma impact and split the monomers into various active species, and a polymerized film is deposited on the surface of the substrate through complex chemical reaction so as to form a surface modification layer of COOH groups on one surface of the substrate. Accordingly, the surface modification layer exhibits the properties of low thickness, high uniformity, low porosity, high adhesion and coverage on the substrate. Herein, the monomers for plasma surface modification can be alcohol compounds. Preferably, the monomers for plasma surface modification are isopropanol.

In the method for biomolecule immobilization according to the present invention, the process for forming the surface modification layer can further comprise grafting polymerization. In detail, the process for forming the surface modification layer can comprise: forming a surface-active layer by plasma surface modification; and subsequently, performing grafting polymerization in the surface-active layer to accomplish a surface modification layer on one surface of the substrate. Herein, the plasma surface modification can be performed by plasma polymerization and monomers for plasma polymerization can be alkenylsilazane compounds. Preferably, the monomers for plasma polymerization are hexamethyldisilazane (HMDSAZ). The grafting polymerization can use alkenic acid compounds as monomers for grafting polymerization. Under UV light, grafting polymerization between the surface-active layer and the monomers can be performed. Preferably, the monomers for grafting polymerization are acrylic acid..

In the method for biomolecule immobilization according to the present invention, the biomolecules can be antibodies, antigens, enzymes, tissues or cells to be employed in a biosensor.

In the method for biomolecule immobilization according to the present invention, the biomolecules can be bonded with the surface modification layer in the presence of a coupling activator. The coupling activator can be selected from the group consisting of N-(3-dimethylaminopropyl)-N′-ethylcarbodiimide (EDC), N-hydroxysuccinimide (NHS) and the combination thereof.

Accordingly, the present invention can reduce manufacturing time, enhance the stability of manufacture, reduce enviromnental pollution and control efficiently the density of bonded molecules by plasma surface modification. In addition, the surface modification layer of the present invention exhibits the properties of low thickness, high uniformity, low porosity, high adhesion and coverage on the substrate. Furthermore, the method for biomolecule immobilization of the present invention can be employed in a biosensor to efficiently enhance sensitivity of the biosensor so as to provide a biosensor with high precision and sensitivity.

Other objects, advantages, and novel features of the invention will become more apparent from the following detailed description when taken in conjunction with the accompanying drawings.

### BRIEF DESCRIPTION OF THE DRAWINGS

FIGS. 1A to 1B show a schematic view of a convention method for biomolecule immobilization;

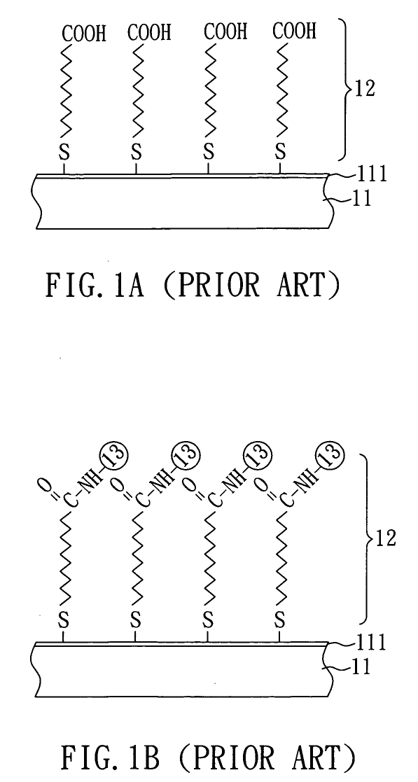

FIGS. 2A to 2B show a schematic view of a method for biomolecule immobilization of a preferred embodiment of the present invention;

FIGS. 3A to 3C show a schematic view of a method for biomolecule immobilization of another preferred embodiment of the present invention.

### DETAILED DESCRIPTION OF THE PREFERRED EMBODIMENT

### Embodiment 1

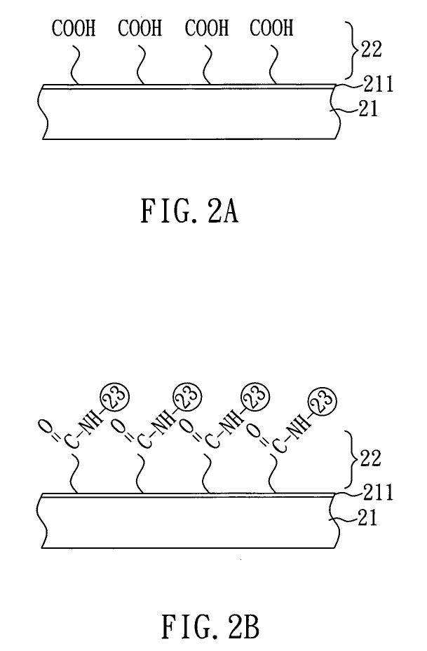

With reference to FIGS. 2A to 2B, there is shown a method for biomolecule immobilization of the present embodiment.

As shown in FIG. 2A, a substrate 21 having a metal film 211 on one surface thereof is first provided. In the present embodiment, the substrate 21 is a silicon substrate and the metal film 211 is a gold film. Subsequently, a surface modification layer 22 is formed on the metal film 211 of the substrate 21 by plasma surface modification.

In the present embodiment, the plasma surface modification is performed by plasma polymerization and uses isopropanol as a monomer for plasma polymerization. In detail, the raw gas of isopropanol is introduced in a vacuum discharge system, and the raw gas is split into various species, followed by the deposition of a polymerized film on the surface of the substrate through complex chemical reaction so as to form a surface modification layer 22 of COOH groups on one surface of the substrate 21. Herein, the surface modification layer 22 exhibits the properties of low thickness, high uniformity, low porosity, high adhesion and coverage on the substrate.

Finally, as shown in FIG. 2B, pluralities of biomolecules 23 are provided and the amino groups of the biomolecules 23 are bonded with the COOH groups of the surface modification layer 22 in the presence of a coupling activator so as to accomplish the routine for biomolecule immobilization. In the present embodiment, the coupling activator is N-(3-dimethylaminopropyl)-N′-ethylcarbodiimide (EDC).

### Embodiment 2

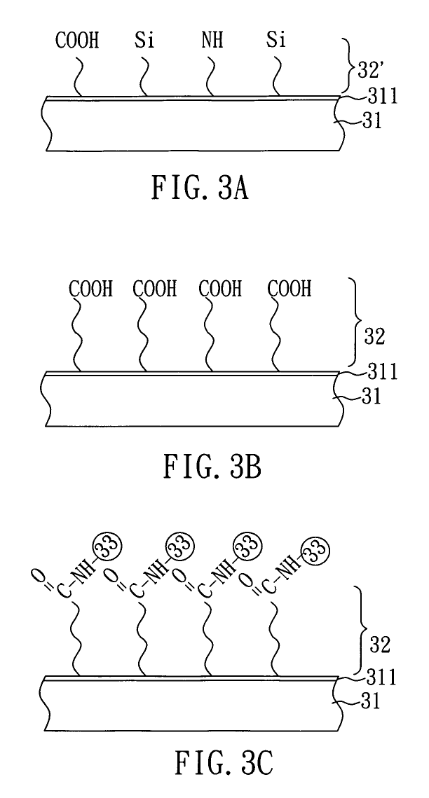

With reference to FIGS. 3A to 3C, there is shown a method for biomolecule immobilization of the present embodiment.

As shown in FIG. 3A, a substrate 31 having a metal film 311 on one surface thereof is first provided. In the present embodiment, the substrate 31 is a silicon substrate and the metal film 311 is a gold film. Subsequently, a surface-active layer 32′ is formed on the metal film 311 of the substrate 31 by plasma surface modification. In the present embodiment, the plasma surface modification is performed by plasma polymerization. The process for plasma polymerization is the same as that in Embodiment 1 except that the present embodiment uses hexamethyldisilazane (HMDSAZ) as a monomer for plasma polymerization. Accordingly, the surface-active layer 32′ is formed, as shown in FIG. 3A.

Then, as shown in FIG. 3B, under UV light, acrylic acid as a monomer for grafting polymerization is bonded to the surface-active layer 32′ as shown in FIG. 3A by grafting polymerization so as to form a surface modification layer 32 of COOH groups on the surface of the substrate 31.

Finally, as shown in FIG. 3C, pluralities of biomolecules 33 are provided and the amino groups of the biomolecules 33 are bonded with the COOH groups of the surface modification layer 32 in the presence of a coupling activator so as to accomplish the routine for biomolecule immobilization. The coupling activator used in the present embodiment is N-(3-dimethylaminopropyl)-N′-ethylcarbodiimide (EDC).

Accordingly, the present invention can reduce manufacturing time, enhance the stability of manufacture, reduce environmental pollution and control efficiently the density of bonded molecules by plasma surface modification. In addition, the surface modification layer of the present invention exhibits the properties of low thickness, high uniformity, low porosity, high adhesion and coverage on the substrate. Furthermore, the method for biomolecule immobilization of the present invention can be employed in a biosensor to efficiently enhance sensitivity of the biosensor so as to provide a biosensor with high precision and sensitivity.

Although the present invention has been explained in relation to its preferred embodiment, it is to be understood that many other possible modifications and variations can be made without departing from the scope of the invention as hereinafter claimed.

What is claimed is:

1. A method for biomolecule immobilization, comprising:
providing a substrate;
forming a surface modification layer of carboxy groups on one surface of the substrate, wherein the process for forming the surface modification layer comprises plasma surface modification; and
providing pluralities of biomolecules and bonding the biomolecules with the surface modification layer.

2. The method as claimed in claim 1, wherein the plasma surface modification is performed by plasma polymerization.

3. The method as claimed in claim 2, wherein the plasma surface modification uses an alcohol compound as a monomer for plasma polymerization.

4. The method as claimed in claim 2, wherein the plasma surface modification uses isopropanol as a monomer for plasma polymerization.

5. The method as claimed in claim 1, wherein the biomolecules are bonded with the surface modification layer in the presence of a coupling activator.

6. The method as claimed in claim 5, wherein the coupling activator is N-(3-dimethylaminopropyl)-N′-ethylcarbodimide.

7. The method as claimed in claim 1, wherein the substrate has a metal film on one surface thereof and the surface modification layer is formed on the metal film.

8. The method as claimed in claim 7, wherein the metal film is a gold film or a silver film.

9. The method as claimed in claim 1, wherein the process for forming the surface modification layer further comprises grafting polymerization.

10. The method as claimed in claim 9, wherein the plasma surface modification is performed by plasma polymerization.

11. The method as claimed in claim 9, wherein the grafting polymerization is performed after the plasma polymerization.

12. The method as claimed in claim 10, wherein the plasma surface modification uses an alkenylsilazane compound as a monomer for plasma polymerization.

13. The method as claimed in claim 10, wherein the plasma surface modification uses hexamethyldisilazane as a monomer for plasma polymerization.

14. The method as claimed in claim 9, wherein the grafting polymerization is performed under UV light.

15. The method as claimed in claim 9, wherein the grafting polymerization uses an alkenic acid compound as a monomer for grafting polymerization.

16. The method as claimed in claim 9, wherein the grafting polymerization uses acrylic acid compound as a monomer for grafting polymerization.

17. The method as claimed in claim 9, wherein the biomolecules are bonded with the surface modification layer in the presence of a coupling activator.

18. The method as claimed in claim 17, wherein the coupling activator is N-(3-dimethylaminopropyl)-N′-ethylcarbodiimide.

19. The method as claimed in claim 9, wherein the substrate has a metal film on one surface thereof and the surface modification layer is formed on the metal film.

20. The method as claimed in claim 19, wherein the metal film is a gold film or a silver film.
